(19) United States
(12) Patent Application Publication
(10) Pub. No.: US 2019/0080695 A1
(43) Pub. Date: Mar. 14, 2019

(54) System and Method for Recording, Transcribing, Transmitting, and Searching Audio Data and Performing Content Parameter Calculations

(71) Applicant: B. van Dam, New York, NY (US)

(72) Inventor: B. van Dam, New York, NY (US)

(21) Appl. No.: 15/892,411

(22) Filed: Feb. 9, 2018

Related U.S. Application Data
(60) Provisional application No. 62/456,604, filed on Feb. 8, 2017.
(60) Provisional application No. 62/517,879, filed on Jun. 10, 2017.
(60) Provisional application No. 62/534,421, filed on Jul. 19, 2017.

(51) Int. Cl. G10L 15/26; G06F 17/30

(52) U.S. Cl. CPC G10L 15/265; G06F 17/30867; G06F 17/30769; G06F 17/30749

(57) ABSTRACT

A system and method for recording, transcribing, transmitting, and searching audio data over a network of computing devices; identifying, analyzing, and performing calculations on content parameters; and displaying audio, transcriptions, and parameter analyses on a graphical user interface.

### BACKGROUND

There is a need to speak thoughts, but no current technological method for recording, saving, multipoint sharing, and searching audio and speech-to-text on a single platform, or analyzing or monetizing content on a single platform.

### SUMMARY

Disclosed is a system, method, and platform that enables users to record audio, transcribe speech to text, save and view audio and speech-to-text on a timeline, identify audio and speech-to-text content using a set of parameters, share audio and speech-to-text with multiple users, view analytics of content across a user's timeline, search audio by keyword, and monetize content.

The platform features an audio recordation component, audio transcription component, analytics identification component, a sharing component, timeline component, an analytics aggregate component, a feed component, channel subscription component, search component, and an export component. The components interact with and communicate data to one another through a system logic, which is embedded in software and/or a server. The platform may additionally comprise a user interface enabling a user to interact with the platform components. The platform may comprise a set of computing devices interacting over a network, exchanging data and data requests. Ideally, the platform is designed to operate on a mobile device, but can be extended to other devices, including computers or dedicated device/hardware systems.

The audio recordation component may feature a microphone built into a mobile device or computer, an audio-to-digital converter, and one or more databases in which an audio signal captured by the microphone and converted by the audio-to-digital converter may be saved. Information relevant to the audio recording, such as the chronological entry number, time, date, and user information, may be automatically created by other components of the platform, associated with the audio recording, and saved with it in a database. The audio recordation component may be coupled to the user interface, enabling the user to communicate to the platform that the user wishes to record audio by selecting a button. The audio transcription component analyzes the audio waves and converts speech to text. This text may then be associated and stored with the audio recording.

The analytics identification component assigns parameter tags to content. These parameter identifiers may include mood, type, characters, and location. The mood parameter may describe an emotion or attitude related to the content, i.e., positive, neutral, or negative, or more specifically, i.e., happy, sad, frightened, or bored. The type parameter may describe the nature of the content, particularly its frequency and/or conscious state. For example, content created by the user may be ordinary, refer to a recurrent thought, or it may be lucid—having occurred during lucid dreaming. The character parameter may identify individuals, groups, or entities, real or fictional, that are subjects of or otherwise relating to the content. One or more individuals, groups, or entities may be inputted and included as character parameters. The location parameter may describe a location relevant to the content or the place in which the content was created or experienced. The analytics identification component may also be coupled to the user interface, allowing the user to select or input parameters. The user may select the parameters by touching or clicking one or more buttons disposed on the user interface or input text, speech, and/or speech-to-text into a field.

The sharing component identifies whether the audio and speech-to-text post can be accessed by just the user, individuals selected by the user, or all users who subscribe to the user. Selecting the friends or public button shares the audio and speech-to-text post with the feed component.

The timeline component organizes posts by chronological entry number. In a preferential version, this entry number is created automatically by the platform and applied consecutively to content posts created by the user. Audio recordings are displayed as posts on a user interface, with interactive buttons and disposed adjacent to text transcriptions of the audio recordings, entry number, and timestamp. Users may select a play button to hear the original audio recording, press again to pause or stop the recording, a comment button to view previous comments and/or leave a comment, and a clap button to like the audio and speech-to-text post (and/or to increase the number of users who have liked the post). Selecting the play button sends a request to the platform to access a database and retrieve the audio clip information, which is then processed into sound by the requesting the user's processor and speakers. Similarly, selecting the comment button may cause the platform to access the database and retrieve and display comments associated with the audio and speech-to-text post. A comment field may be displayed, permitting the user to comment on the audio and speech-to-text post via text, speech, and/or speech-to-text. This comment may then be saved by the platform to the database and associated with the post.

The analytics aggregate component shows parameters including the mood, type, characters, and/or location by percentage for a user's content posts. It executes calculations using information stored in the database relating to the data on mood, type, characters, and location. These calculations may include identifying averages for any given instantiation of mood among all instantiations of mood. These calculations may be similarly executed for type, characters, and location. Calculations may also include identifying the instantiations as percentages of the total instantiations for the parameter class. When the analytics aggregate component is coupled to the user interface, these averages and/or percentages may be displayed. For example, an analytics screen may display the percent of a user's content that are identified as positive, neutral, and negative.

The feed component may feature audio and speech-to-text information of content created by users who have accepted friend requests or sent accepted friend requests, or channel users they have subscribed to. When coupled to the user interface, content may be displayed in the order in which the posts were created, with more recent posts appearing more prominently and/or above less recent posts. Similarly to the way in which interaction options are displayed and accessed on the timeline, a user may press to play the audio recording, press again to stop the audio recording, view and leave comments via displays and input fields, like and increase user engagement, and view text transcriptions of the audio recordings, the chronological entry number for the posting user, and timestamp. These posts may also identify the user adjacent to the text transcriptions, along with the location identified by the posting user or recorded by the platform.

The search component features a search engine and input field of text, speech, and/or speech-to-text where a user can input one or more keyword(s). The search engine then searches all posts that are saved publicly on the platform or displayed in the feed and timeline, for speech-to-text transcriptions comprising the keyword(s). The platform may then display the results in a similar format to posts on the feed screen, where a user may press to play the audio recording, press again to stop the audio recording, view and leave comments via displays and input fields, like and increase user engagement, and view text transcriptions of the audio recordings, the chronological entry number for the posting user, and timestamp.

The channel subscription component enables users to publicize their content, thereby giving subscribers access to view their content that are saved as public, in the feed screen. A user may search for channel users. The platform may receive a subscription request from a user for the account of a channel user. The channel subscription component may be coupled to a payment component. The platform may require receipt of user payment or an agreement to pay before enabling a subscription event. The payment component may be coupled to a user interface in which the user may enter payment details, such as credit card information. Alternatively, the payment component may be connected to an SDK of a payment processor. Payment received from the user may be transmitted to a bank account managed by the platform. Payment may then be divided and transmitted monthly or regularly to the email of the user being subscribed to via a payment processor such as PayPal, for example, based on the monthly difference in the amount of users who have subscribed to a channel user.

The export component enables users to transfer audio and speech-to-text posts to an inputted email for other use independent from the platform. The export component may be coupled to the user interface that displays an input field where a user can input an email address. The user interface may have an anonymous button that can be selected to replace the user's identification information, such as name, in the export. Once the request is received by the platform, audio and speech-to-text data are sent in the body of an email, in which case audio information may be embedded therein as a link to the audio file stored in the platform's database that can be downloaded and/or an audio player. Alternately, the posts are copied as several distinct files, including separate audio and text files. These files are then send via the export component, which may have access to an email server or engage with an API from an email platform, to the address identified.

### BRIEF DESCRIPTION OF THE DRAWINGS

FIG. 1 is a flowchart showing an exemplary process.

FIG. 2 is a flowchart showing an exemplary process.

FIG. 3 is a flowchart showing an exemplary process.

FIG. 4 is a flowchart showing an exemplary process.

FIG. 5 is a flowchart showing an exemplary process.

FIG. 6 is a flowchart showing an exemplary process.

FIG. 7 is a flowchart showing an exemplary process.

FIG. 8 is a flowchart showing an exemplary process.

FIG. 9 shows an exemplary system.

FIG. 10 shows an exemplary user interface.

FIG. 11 shows an exemplary user interface.

FIG. 12 shows an exemplary user interface.

FIG. 13 shows an exemplary user interface.

FIG. 14 shows an exemplary user interface.

FIG. 15 shows an exemplary user interface.

FIG. 16 shows an exemplary user interface.

FIG. 17 shows an exemplary user interface.

FIG. 18 shows an exemplary user interface.

### DETAILED DESCRIPTION

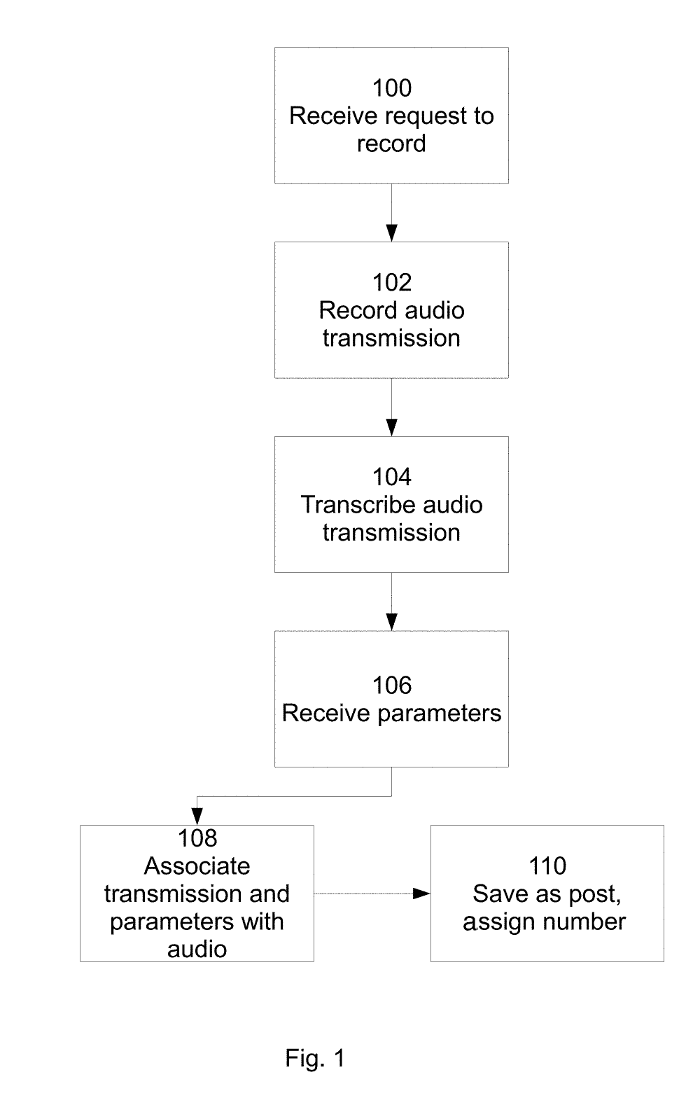

As shown in FIG. 1, the processor is programmed to 100 receive a request from the user to record an audio transmission, 102 record the audio transmission, 104 transcribe the audio transmission to a text transcription, 106 receive parameter selections or entries from the user, 108 associate the audio transcription and parameters with the audio transmission, and 110 save the audio transcription, transmission, and parameters as a post, and assign a consecutive number to the post.

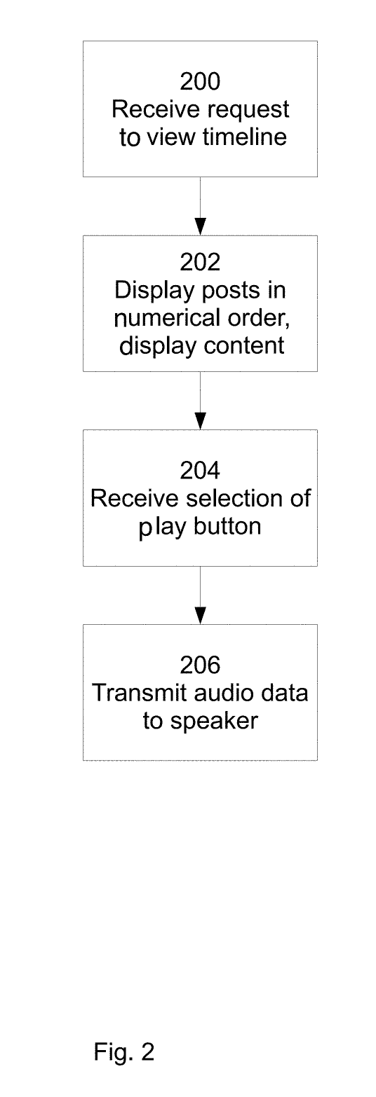

As shown in FIG. 2. the processor is programmed to 200 receive a request from the user to view the timeline, 202 display the posts in consecutive order and display the content of those posts, 204 receive a selection of the play button by the user, and 206 transmit audio data to the speaker.

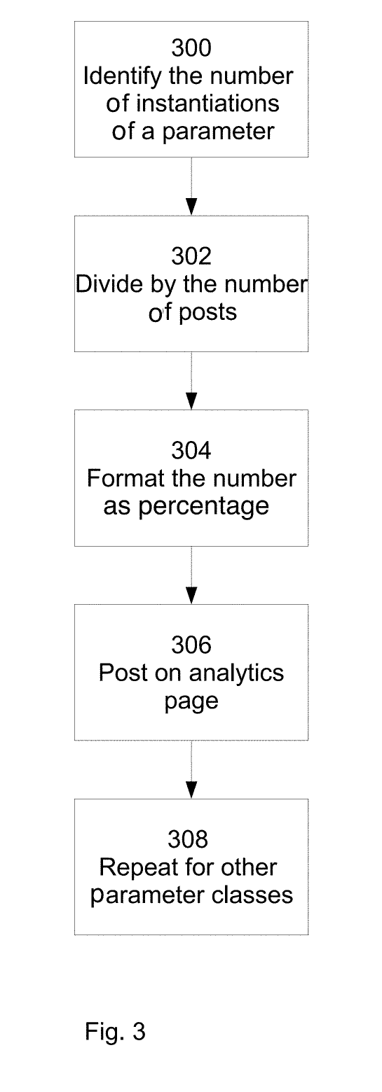

As shown in FIG. 3, the processor is programmed to 300 identify the number of instantiations of a parameter, 302 divide that number by the number of posts, 304 format the number as a percentage, 306 post that percentage on an analytics page, and 308 repeat this process for other parameter classes.

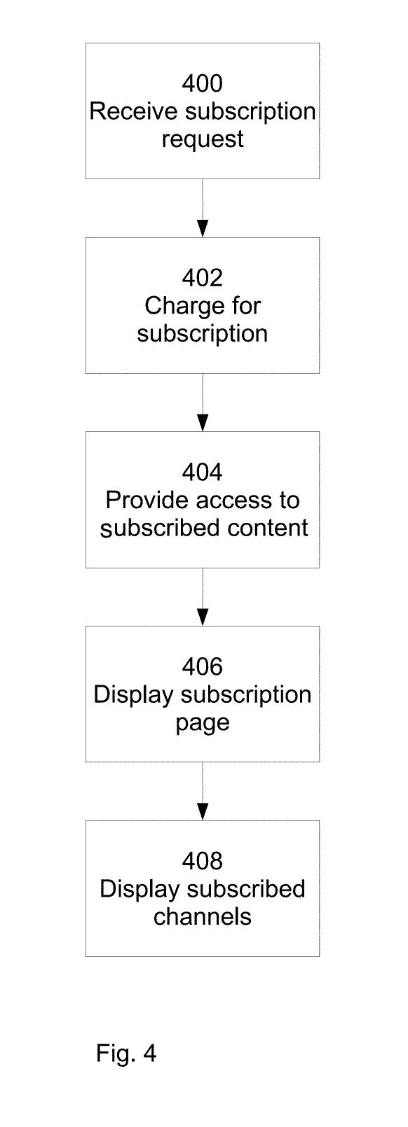

As shown in FIG. 4, the processor is programmed to 400 receive a subscription request, 402 charge for the subscription, 404 provide access to the subscribed content, 406 display the subscriptions page, and 408 display subscribed channels.

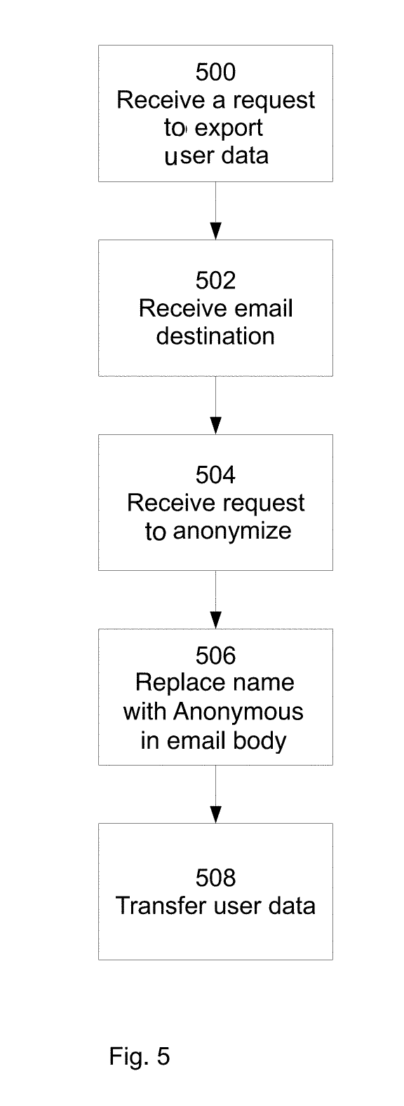

As shown in FIG. 5, the processor is programmed to 500 receive a request to export user data, 502 receive an email destination from the user, 504, receive a request to anonymize the user data, 506 replace the user name with anonymous in the email body, and finally 508 transfer the user data by emailing it to the email destination.

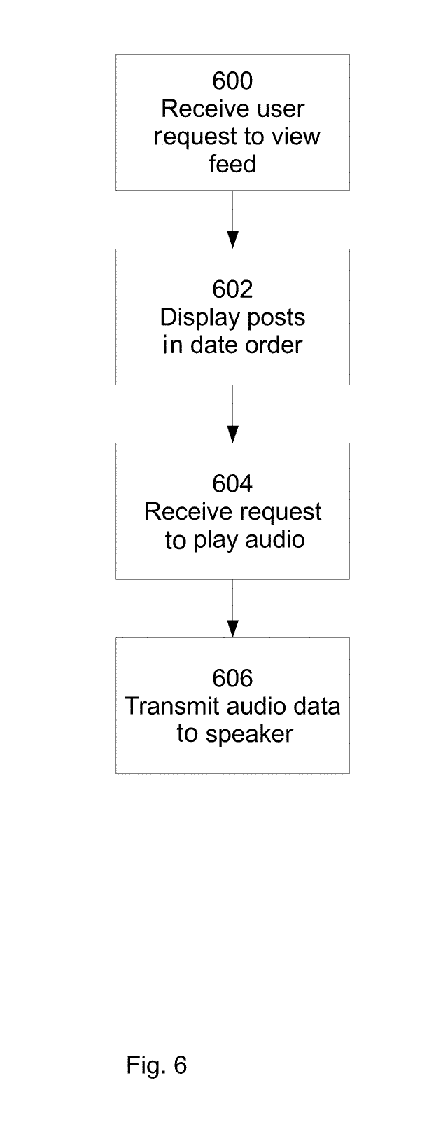

As shown in FIG. 6, the processor is programmed to 600 receive a user request to view the feed, 602 display posts on the feed page in consecutive or date order, 604 receive a request to play the audio for a particular post, and 606 transmit audio data to the speaker.

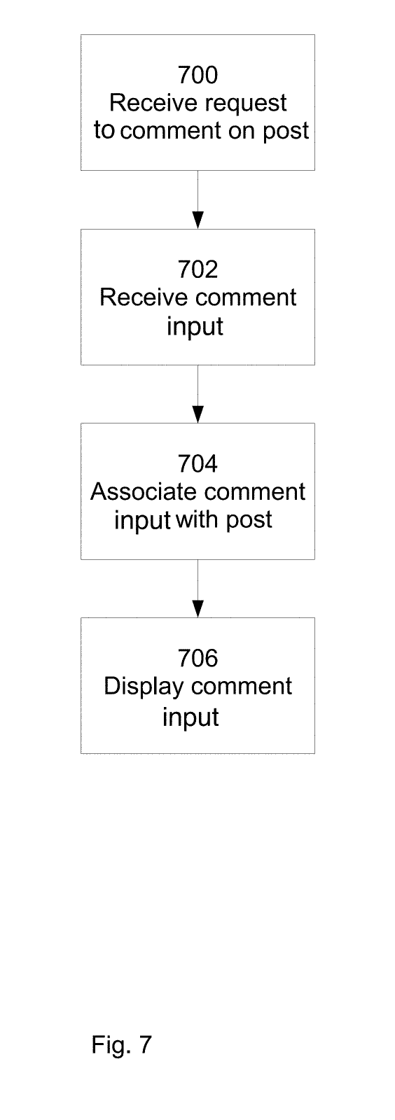

As shown in FIG. 7, the processor is programmed to 700 receive a request to comment on a post, 702 receive comment input, 704, associate the comment input with the post, and 706 display the comment input.

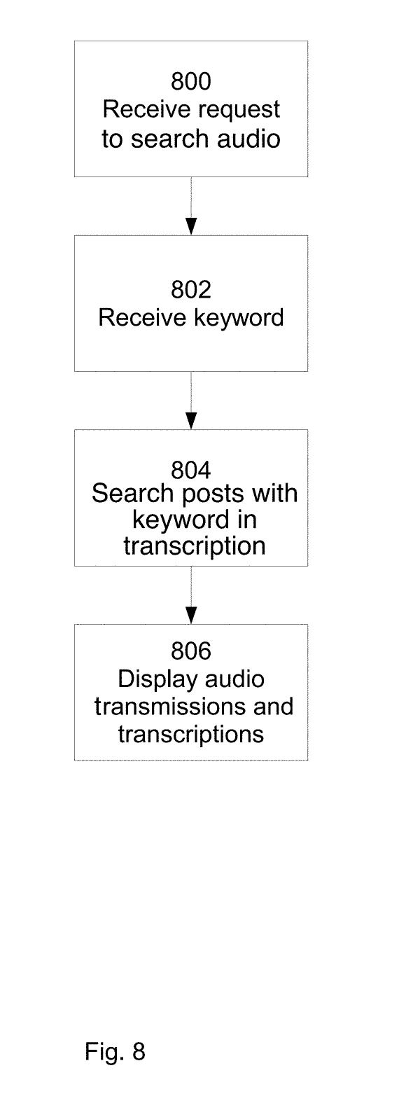

As shown in FIG. 8, the processor is programmed to 800 receive a request to search for audio, 802 receive a keyword, 804 search posts using the keyword, and 806 display audio transmissions and transcriptions that are associated or include the keyword.

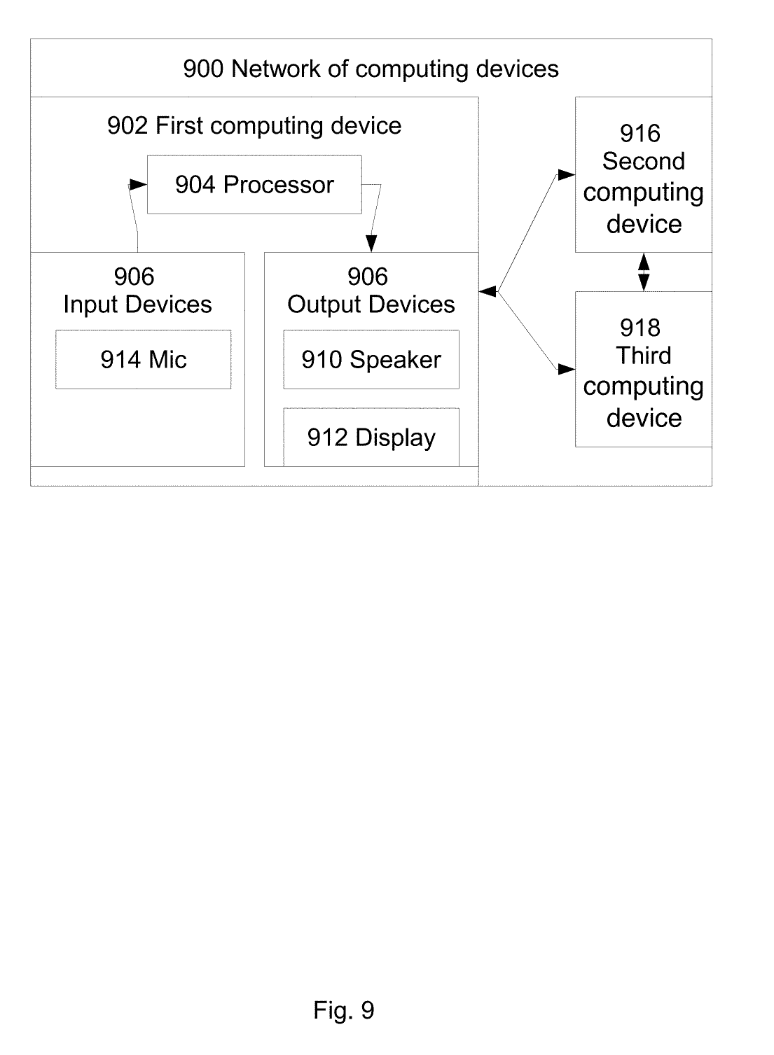

As shown in FIG. 9, the system may feature a 900 network of computing devices, including 902 a first computing device, 916 a second computing device, and 918 a third computing device. A computing device may comprise 904 a processor which is connected to 906 input devices, including 914 a microphone, and 906 output devices, including 910 a speaker and 912 a display device.

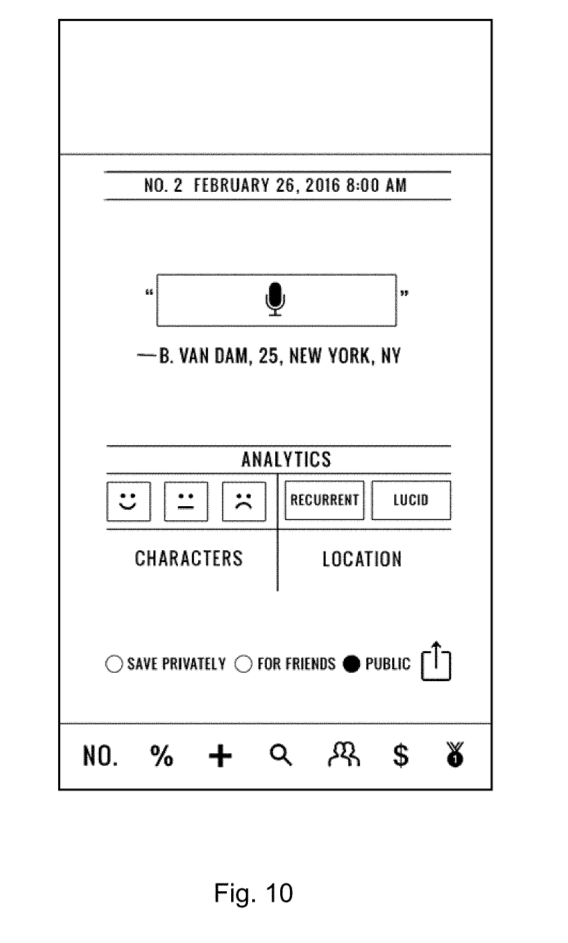

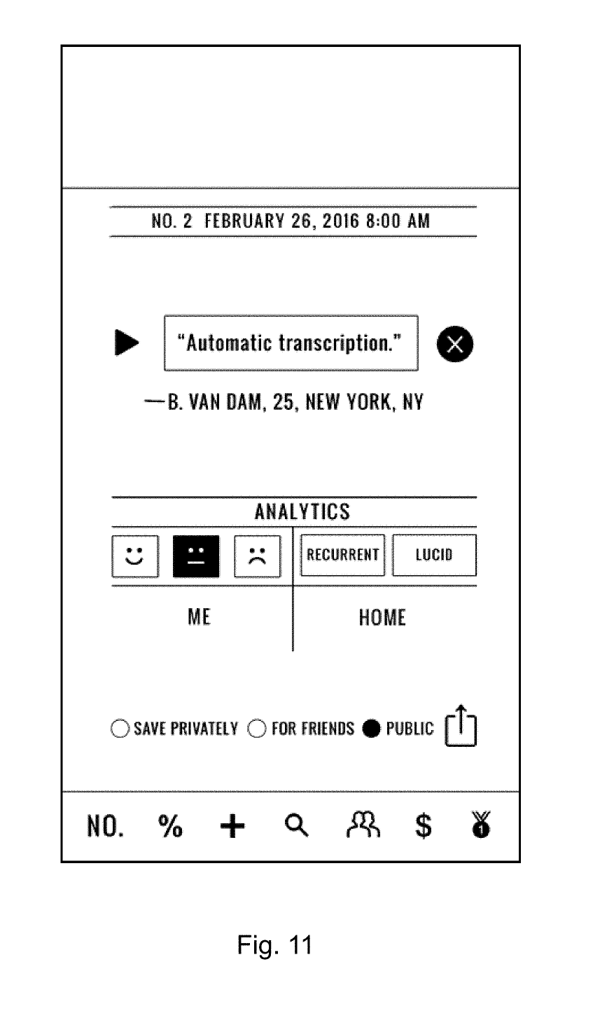

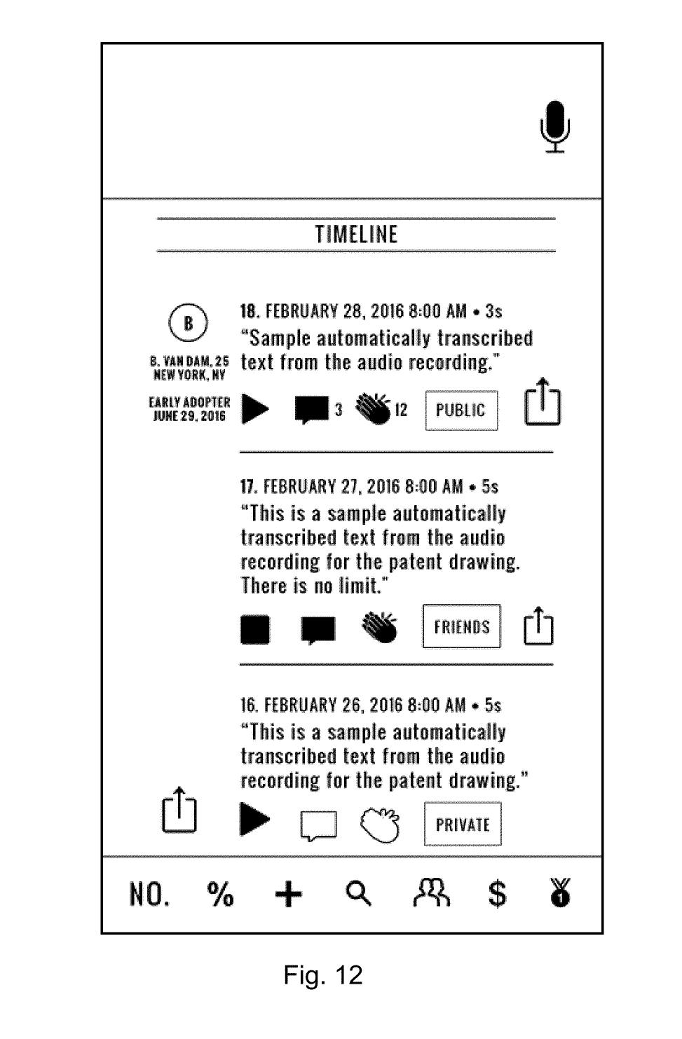

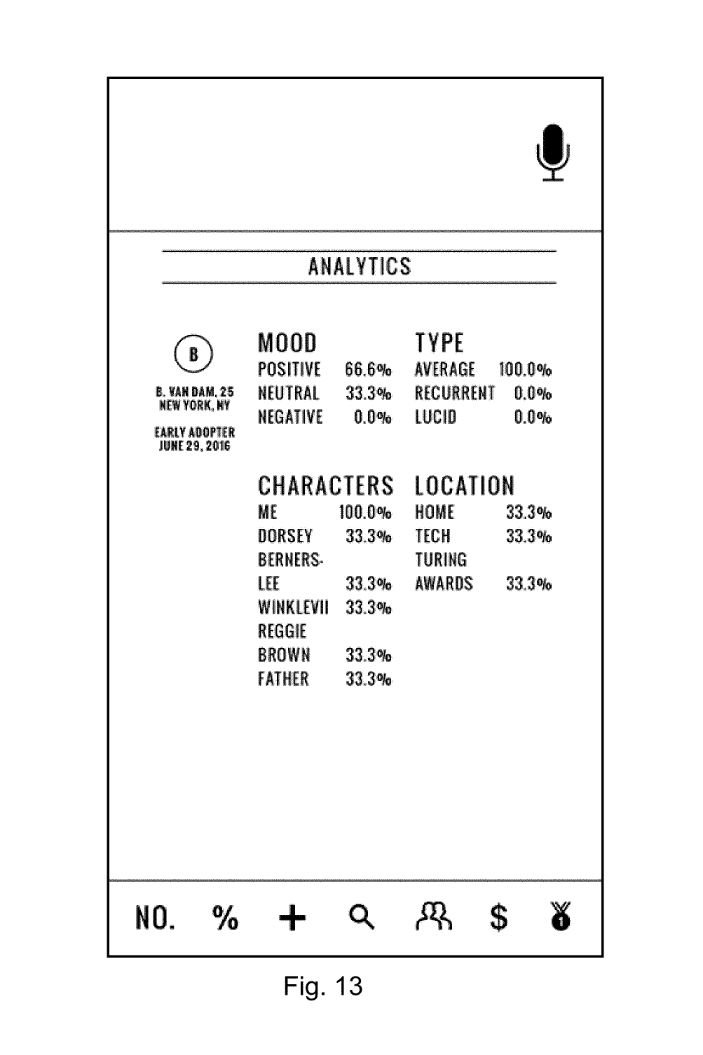

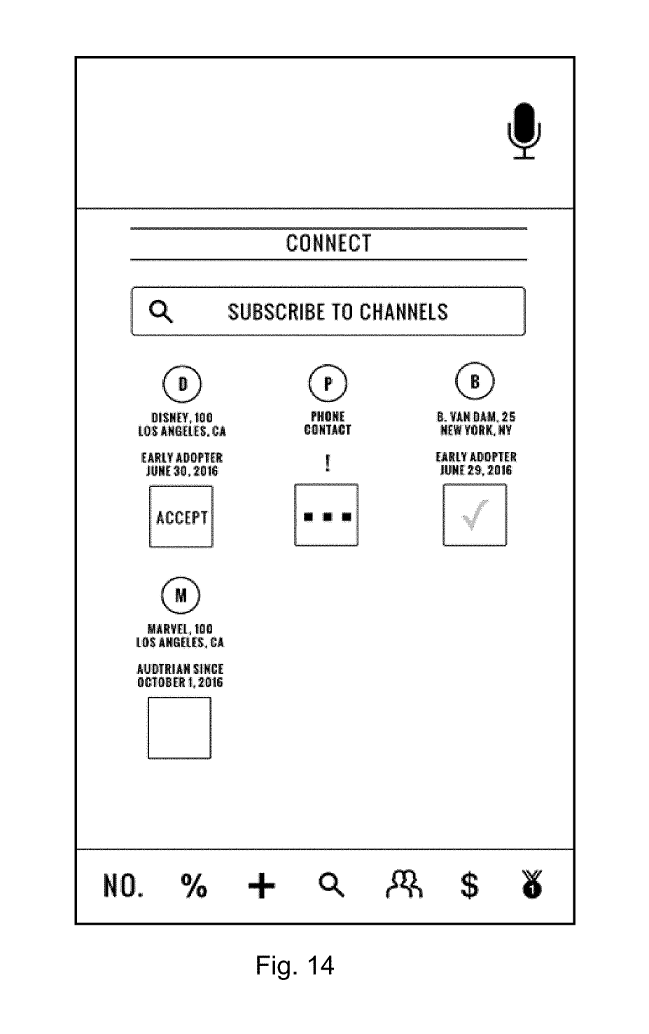

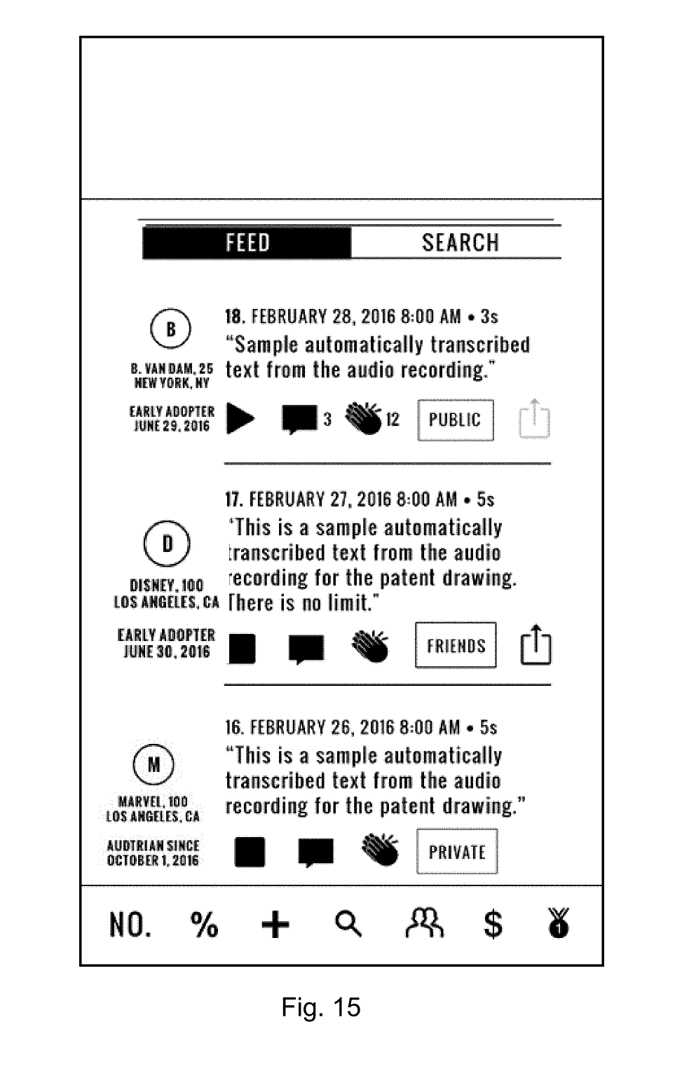

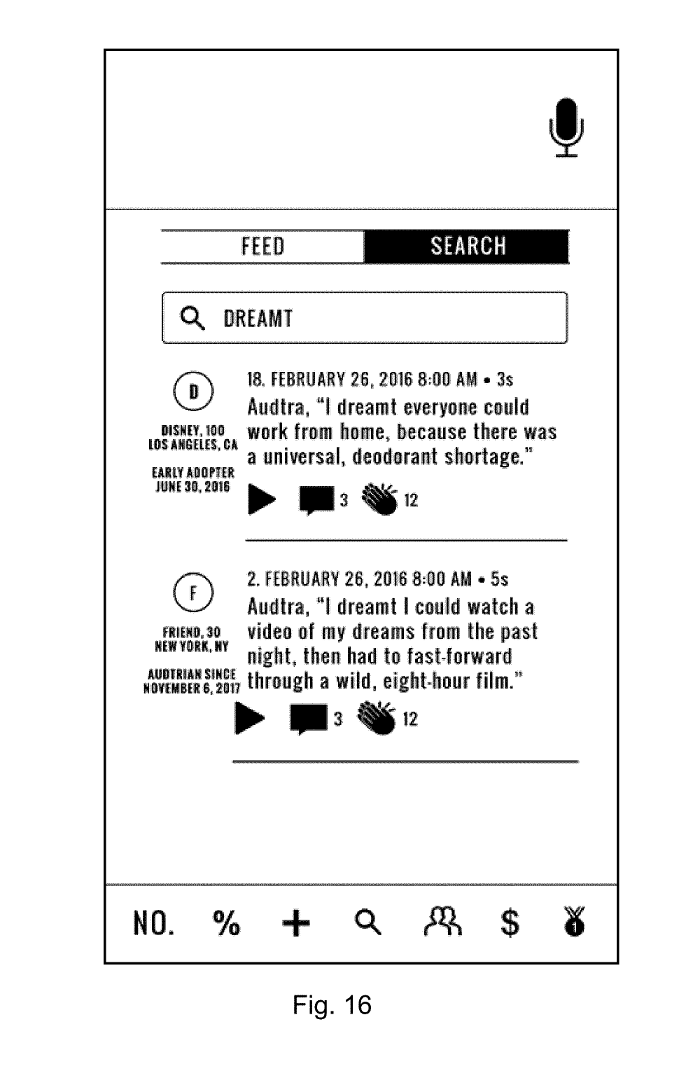

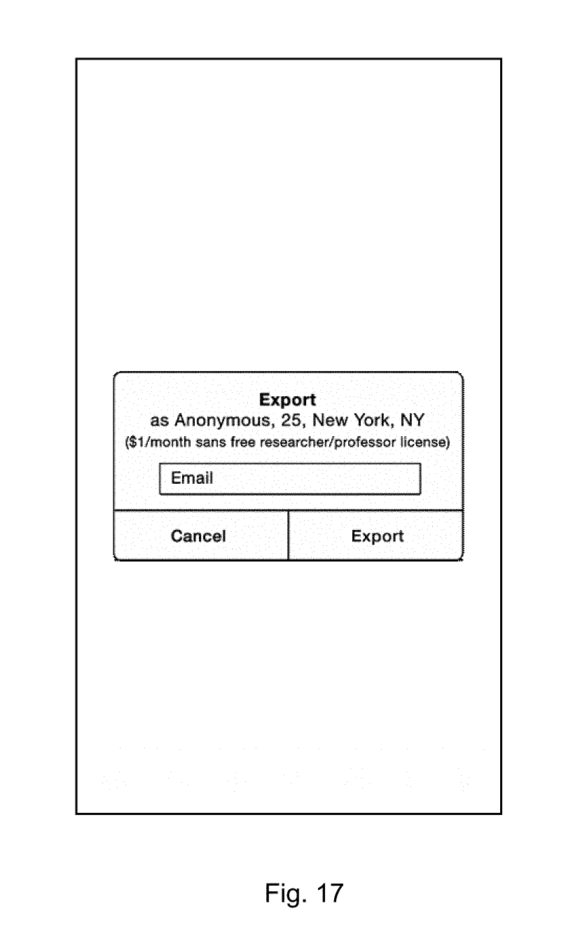

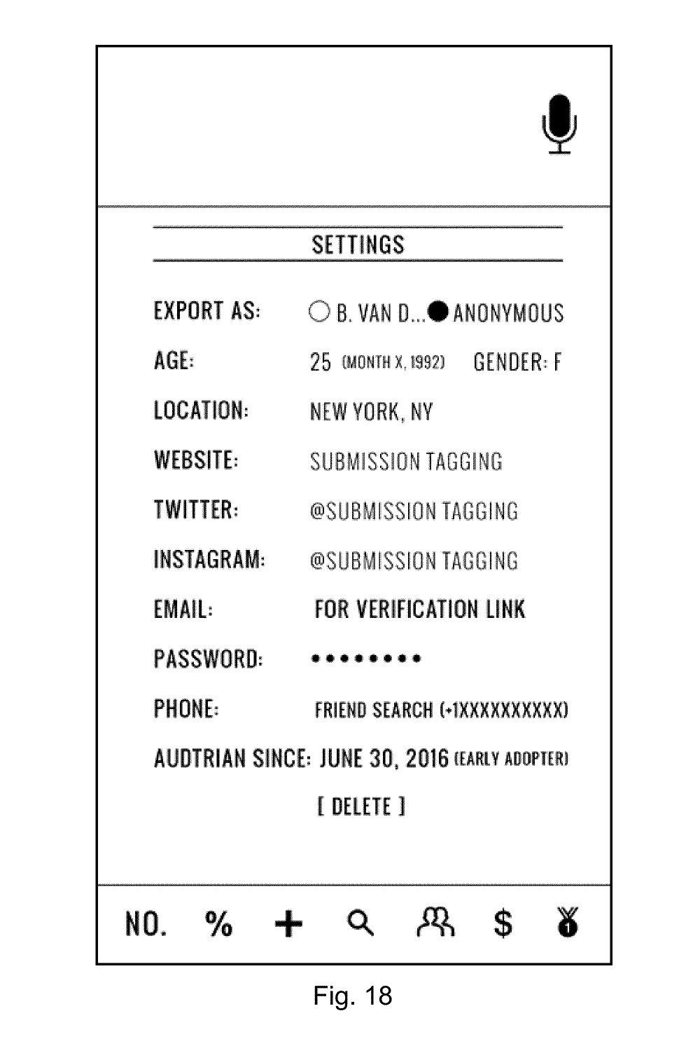

As shown in FIGS. 10-18, the system may be coupled to a user interface.

1. A system comprising a first processor and a second processor, the first and second processor connected over a network,
a. the first processor configured to be used by a first user, coupled to a first set of one or more input devices, a first set of one or more display devices, a first speaker, and a microphone, and programmed to:
b. receive a request from the first user to record audio, then receive and record a first audio transmission using the microphone, then transcribe the first audio transmission as a first text, save the first audio transmission as a first audio data set, and associate the first text with the first audio data set;
c. receive a first set of mood, type, characters, and location parameters from the first user, and then associate the first set of parameters with the first audio data set;
d. receive a request from the first user to see a timeline page, display posts in a numerical order with each new post being assigned a number consecutively higher than a previous post,
e. display the first text adjacently to a play button on a first post on the timeline page, then receive a selection of the play button from the first user, then transmit the first audio data set to the first speaker;
f. calculate a percentage for each instantiation of the mood parameter, the type parameter, the characters parameter, and location parameter;
g. receive a request from the first user to see an analytics page, then display the percentage for each instantiation of the parameters;
h. receive a request from the first user to see a connect page, then display the connect page, a user interface configured to search and subscribe to a second user, and display subscriptions;
i. receive a request from the first user to export user data, then display an email address field, then receive an email address from the first user, then remove identification information from the user data, then transmit user data to the email address;
j. the second processor programmed to be used by the second user, coupled to a second set of one or more input devices, a second set of one or more display screens, and a second speaker, and programmed to:
k. receive a request from the second user to see a feed page using the second set of one or more input devices, then display the first text, a second text transcribed from a second audio transmission recorded by a third user, then receive a selection of the play button from the second user, then transmit the second audio data set to the second speaker;
l. receive a comment request from the second user, then receive second user comments via the second set of input devices, then associate the second user comments with the first audio transmission;
m. receive a request from the second user to subscribe to a fourth user; then prompt the second user for payment; then receive payment or an agreement to pay from the second user; then provide access to transcribed texts and audio transmissions made by the fourth user to the second user;
n. receive a request from the second user to search the timeline, feed, or posts made by the fourth user, receive a keyword from the second user using the second set of input devices, and then display audio transmissions and transcriptions containing or associated with the keyword.

2. A system comprising a network of processors, at least one processor in communication with a microphone, a set of input devices, a display screen, and a speaker, configured to be used by a user, and programmed to receive a request from the user to record an audio transmission using the set of input devices, then record the audio transmission using the microphone, then transcribe the audio transmission into text, then receive parameter selections from the user, then assign those parameter selections to the audio transmission, then assign a chronological number to each audio transmission and transcribed text, then display the transcribed text and a UI control to play the audio transmission on a single timeline page on the display screen, then receive a request to play the audio transmission, and then send audio transmission data to the speaker.

3. The system in claim 2, the at least one processor additionally programmed to calculate a percentage of selections for each parameter using a total number of parameter selections, then display the percentage for each parameter on an analytics page on the display screen.

4. The system in claim 2, the at least one processor additionally programmed to receive a request from the user to see a connect page using the one or more input devices, then display the connect page, then receive a search and subscription request from the user, then display the subscriptions on the display screen.

5. The system in claim 2, the at least one processor additionally programmed to receive a request from the user to export user data using the set of one or more input devices, then display an email address field on the display screen, then receive an email address from the first user in a text entry field, then remove identification information from the user data, then transmit user data to the email address.

6. The system in claim 2, the at least one processor additionally programmed to receive a request from the user to see a feed page using the set of one or more input devices, then display transcribed texts and UI controls to play audio transmissions, then receive a request to play an audio recording, and then send audio data to the speaker.

7. The system in claim 6, the at least one processor additionally programmed to receive a request to comment on a post from the user using the set of one or more input devices, then display a comment field on the display device, then receive user comments, then associate the user comments with the post, and then post the user comments adjacent to or within an expandable graphical area adjacent to the post.

8. The system in claim 4, the at least one processor additionally programmed to, upon receiving the subscriptions request, prompt the user for payment, and then upon receiving payment, provide access to transcribed texts and audio transmissions of a particular user through the feed page.

9. A system comprising a computing device, the computing device comprising an input interface, a display screen, a speaker, a processor, and a microphone, the processor programmed to receive an audio transmission, transcribe the transmission into text, assign a chronological number to the audio transmission, and receive parameter selections, the number being sequentially higher than a previously assigned number.

10. The system in claim 9, with parameters being selected from a set that includes positive, neutral, and negative.

11. The system in claim 9, with parameters being selected from a set that includes recurrent and lucid.

12. The system in claim 9, with an instantiation of a parameter being entered as text via the input interface.

13. The system in claim 9, with parameters being determined using GPS or text via the input interface.

14. The system in claim 9, the processor additionally programmed to calculate a percentage for each instantiation of a parameter expressing the number of times each instantiation is selected or entered compared to a total number of posts.

15. The system in claim 14, the processor additionally programmed to display the percentage for each instantiation of a parameter on the display screen.

16. The system in claim 9, the processor additionally programmed to prompt for a subscription fee upon receiving a subscription request.

17. The system in claim 16, the subscription request relating to accessing posts made by a particular user.

18. The system in claim 17, the subscription fee being paid or divided and paid to the particular user.

19. The system in claim 17, the subscription fee being paid to the system.

20. The system in claim 9, the processor additionally programmed to share a post comprising a transcription and an audio transmission made by a user with multiple users in a single feed page upon receiving a single click from the user.
